(19) United States
(12) Patent Application Publication
(10) Pub. No.: US 2023/0107349 A1
(43) Pub. Date: Apr. 6, 2023

(54) WALKING SUPPORT SYSTEM, WALKING SUPPORT METHOD, AND WALKING SUPPORT PROGRAM

(71) Applicant: The Pokémon Company, Tokyo (JP)

(72) Inventors: Taku KAWAMOTO, Tokyo (JP); Kenji OKI, Tokyo (JP)

(73) Assignee: The Pokémon Company, Tokyo (JP)

(21) Appl. No.: 18/078,108

(22) Filed: Dec. 9, 2022

Related U.S. Application Data
(63) Continuation of application No. PCT/JP2021/010203, filed on Mar. 12, 2021.

(30) Foreign Application Priority Data
Jun. 11, 2020 (JP) 2020-101342

(51) Int. Cl. G01C 21/34; G01C 21/36

(52) U.S. Cl. CPC G01C 21/3461; G01C 21/3492; G01C 21/3484; G01C 21/3617; G01C 21/3626

(57) ABSTRACT

A walking support system including processing circuitry for determining a recommended route for a participant in a space where the participant can choose and walk along a route, and guiding the participant to the recommended route without restricting entry of the participant into a non-recommended route, which is a different route to the recommended route.

### CROSS-REFERENCE TO RELATED APPLICATIONS

This is a Bypass Continuation of International Application No. PCT/JP2021/010203, filed Mar. 12, 2021, which claims priority to JP 2020-101342, filed Jun. 11, 2020, the entire contents of each are incorporated herein by its reference.

### BACKGROUND

### Field

The present disclosure relates to a walking support system, a walking support method, and a walking support program.

### Description of Related Art

In recent years, experience-based events known as night walks have been gaining attention. On a typical night walk, participants walk through an outdoor facility decorated with illuminations at night.

On a night walk described in NPL 1, the participants can enjoy digital art by walking along a predetermined route. More specifically, several points are set along the route. At each point, digital art is expressed by decorating trees, rocks, and so on using laser beams or projection mapping.

### CITATION LIST

### Non Patent Literature

[NPL 1] “Tonga Lumina Tremblant | A night walk in search of the giant”, online, retrieved on 21 May 2020, Internet <URL: https://www.tongalumina.ca/en/>

### SUMMARY

### Technical Problems

On the night walk described in NPL 1, the route along which the participants walk is a single road. Therefore, although the participants do not need to worry about where to go, the participants have almost no freedom to choose their actions. Moreover, in this type of event, although the experience obtained by the participants remains constant, it is unlikely that repeated participation will lead to unknown discoveries or unforeseen occurrences. Hence, it is difficult to motivate the participants to use the service repeatedly.

On the other hand, when an attempt is made to secure freedom for the participants to choose their actions, the participants may become lost or concerned about whether they have chosen an appropriate route.

An object of the present disclosure is to secure freedom of action selection while guiding participants appropriately.

### Solutions to Problems

A walking support system according to an aspect of the present disclosure includes means for determining a recommended route for a participant in a space where the participant can choose and walk along a route, and means for guiding the participant to the recommended route without restricting entry of the participant into a non-recommended route, which is a different route to the recommended route.

According to the present disclosure, freedom of action selection can be secured while guiding participants appropriately.

### BRIEF DESCRIPTION OF DRAWINGS

FIG. 1 is a block diagram showing a configuration of a walking support system according to one or more aspects of the disclosed subject matter.

FIG. 2 is a block diagram showing a configuration of an effect control device according to one or more aspects of the disclosed subject matter.

FIG. 3 is a diagram illustrating an exemplary application of the walking support system according to one or more aspects of the disclosed subject matter.

FIG. 4 is a diagram illustrating an exemplary application of the walking support system according to one or more aspects of the disclosed subject matter.

FIG. 5 is a diagram illustrating an exemplary application of the walking support system according to one or more aspects of the disclosed subject matter.

FIG. 6 is a diagram showing a data structure of a branch area database according to one or more aspects of the disclosed subject matter.

FIG. 7 is a diagram showing a data structure of a route database according to one or more aspects of the disclosed subject matter.

FIG. 8 is a diagram showing a data structure of a participant database according to one or more aspects of the disclosed subject matter.

FIG. 9 is a flowchart showing walking support processing according to one or more aspects of the disclosed subject matter.

FIG. 10 is a flowchart showing an example of participant guidance processing shown in FIG. 9.

FIG. 11 is a flowchart showing an example of participant guidance processing according to one or more aspects of the disclosed subject matter.

FIG. 12 is a diagram showing an example of effect content implemented for the purpose of guidance.

FIG. 13 is a diagram showing an example of effect content implemented for the purpose of guidance.

FIG. 14 is a diagram showing an example of effect content implemented for the purpose of guidance.

### DETAILED DESCRIPTION

The present disclosure will be described in detail below on the basis of the drawings. Note that in the diagrams used to illustrate an embodiment, identical constituent elements will in principle be allocated identical reference symbols, and repetitive description thereof will be omitted.

### (1) Configuration of Walking Support System

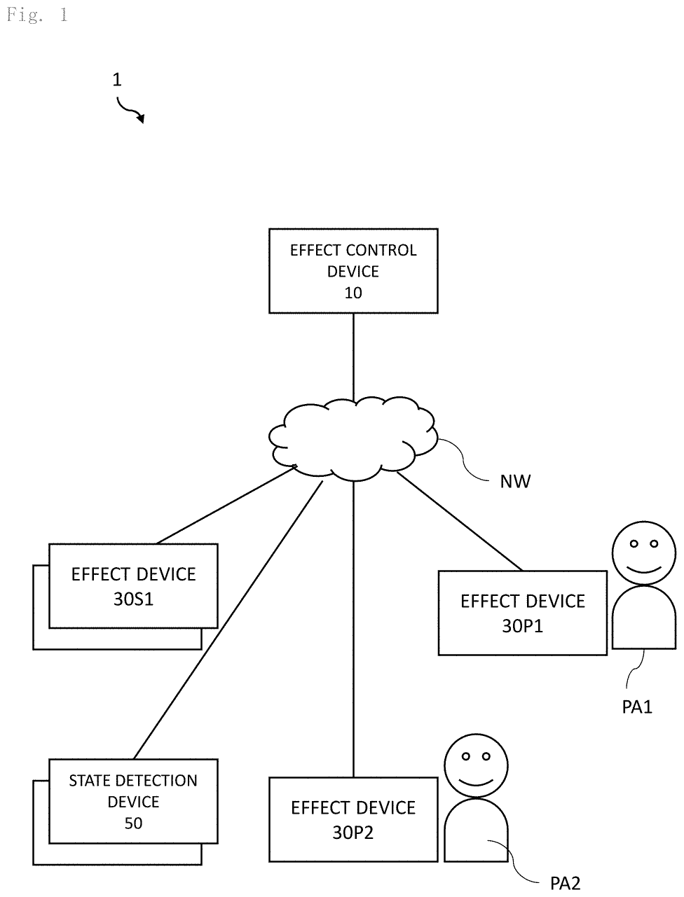

A configuration of a walking support system will now be described. FIG. 1 is a block diagram showing a configuration of a walking support system according to this embodiment.

The walking support system according to this embodiment provides a person (referred to hereafter as a “participant”) participating in an event of walking through a space with walking support.

As shown in FIG. 1, a walking support system 1 includes an effect control device 10, an effect device 30 (for example, an effect device 30S1, an effect device 30P1, and an effect device 30P2), and a state detection device 50 (for example, a state detection device 50B1).

The effect control device 10 is connected to the effect device 30 and the state detection device 50 by a network (for example, the Internet or an intranet) NW.

The effect control device 10 is a computer, for example.

The effect control device 10 controls operations of the effect device 30. The effect control device 10 acquires information relating to the state of the participant, the effect device 30, or the space from the state detection device 50.

The effect device 30 is a device that can produce an effect by applying sensory stimulation to the participant. The effect device 30 operates in accordance with control executed by the effect control device 10.

The sensory stimulation is, for example, stimulation of at least one of the sight, hearing, touch, smell, and taste of the participant.

The effect is performed with the aim of decorating the space or supporting the walking performed by the participant. Supporting the walking performed by the participant means, for example, indicating a recommended route, to be described below, indicating selectable routes, indicating that entry is prohibited, or a combination thereof.

The effect device 30 includes at least one of an effect device that is carried by the participant (for example, the effect device 30P1, which is carried by a participant PA1, and the effect device 30P2, which is carried by a participant PA2) and an effect device disposed in the space (for example, the effect device 30S1).

The effect device 30 carried by the participant may be a mobile computer (a smartphone, for example), a wearable device (smart glasses, a transmissive HMD (Head Mounted Display), or a smartwatch), or the like. The effect device 30 carried by the participant may be provided (for example, loaned or assigned) by the event organizer, or may be a personal item owned by the participant, or may be formed by combining a part (for example, a pen light that can be connected to a USB (Universal Serial Bus)) or an application provided by the event organizer with a personal item owned by the participant.

A specific example of the effect device 30 is described below. However, the effect device 30 is not limited to the following example.

The effect device 30 includes light-emitting means (a light source, for example).

The effect device 30 includes means for displaying images (a display, for example). For example, the effect device 30 carried by the participant may display AR (Augmented Reality) images, MR (Mixed Reality) images, or SR (Substitutional Reality) images.

The effect device 30 includes means for projecting video (a projector, for example).

The effect device 30 includes means for outputting sound (a speaker, for example).

The effect device 30 includes means for generating vibration (a haptic device, for example).

The effect device 30 includes means for generating odors (an aroma device, for example).

The effect device 30 includes means for stimulating the taste of the participant (for example, a mouthpiece-type device capable of supplying the tongue of the participant with a taste-stimulating liquid).

The effect device 30 includes self-moving means or self-attitude changing means (a robot, for example).

The effect device 30 includes means for operating electrically controllable machinery.

The effect device 30 includes means for generating physical phenomena (fog, smoke, a water flow, an air flow, heat, fire, or electrical discharge, for example) that can be sensed by the participant.

The state detection device 50 detects the state of the participant, the effect device 30, or the space, and transmits a detection result to the effect control device 10.

The state of the participant is, for example, the location of the participant, the attitude of the participant, the gaze direction of the participant, the total walking distance of the participant, the total walking time of the participant, the walking speed of the participant, the vitals of the participant, or a combination thereof.

The state of the effect device 30 is, for example, the location of the effect device 30 carried by the participant, the attitude of the effect device 30 carried by the participant, or a combination thereof.

The state of the space is, for example, the temperature, the humidity, the air flow, the brightness, or a combination thereof.

The state detection device 50 is typically disposed in the space but may be carried by the participant (for example, the state detection device 50 may be included in the effect device 30 carried by the participant).

Specific examples of the state detection device 50 are described below. However, the state detection device 50 is not limited to the following examples.

A human sensor

A distance measurement sensor

A GPS receiver

A positioning system using beacons

An optical sensor (a camera, for example)

A timer

A microphone

An acceleration sensor

An angular velocity sensor

A vitals sensor

A temperature sensor

A humidity sensor

An air flow sensor

A brightness sensor

(1-1) Configuration of Effect Control Device

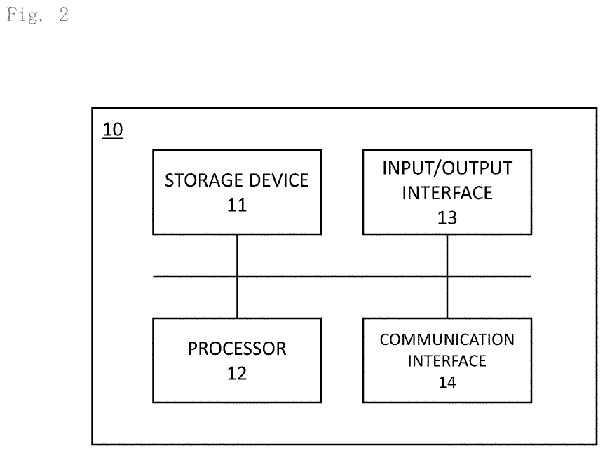

A configuration of the effect control device according to this embodiment will now be described. FIG. 2 is a block diagram showing a configuration of the effect control device according to this embodiment.

As shown in FIG. 1, the effect control device 10 includes a storage device 11, a processor 12, an input/output interface 13, and a communication interface 14.

The storage device 11 is configured to store programs and data. For example, the storage device 11 is a combination of a ROM (Read Only Memory), a RAM (Random Access Memory), and storage (a flash memory or a hard disk, for example).

The programs include the following programs, for example.

An OS (Operating System) program

A program for an application (a walking support application, for example) that executes information processing

The data include the following data, for example.

A database that is referred to during the information processing

Data acquired by executing the information processing (in other words, execution results of the information processing)

The processor 12 is configured to realize the functions of the effect control device 10 by activating the programs stored in the storage device 11. The processor 12 is an example of a computer. It should be appreciated that the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The input/output interface 13 is configured to acquire user instructions from an input device connected to the effect control device 10 and output information to an output device connected to the effect control device 10.

The input device is a keyboard, a pointing device, a touch panel, or a combination thereof, for example.

The output device is a display, for example.

The communication interface 14 is configured to control communication between the effect control device 10 and external devices (for example, the effect device 30 and the state detection device 50).

### (2) Outline of Embodiment

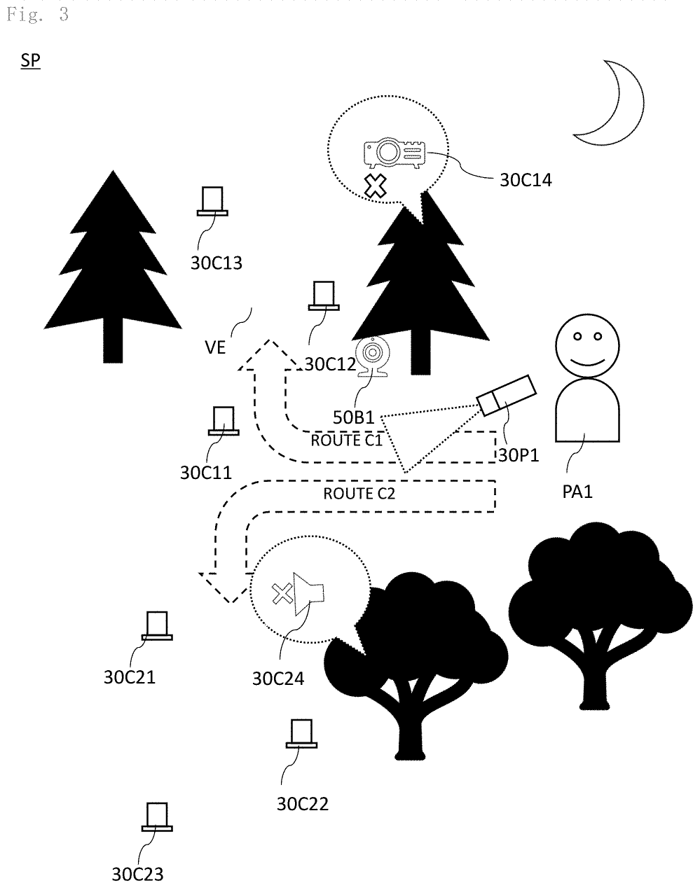

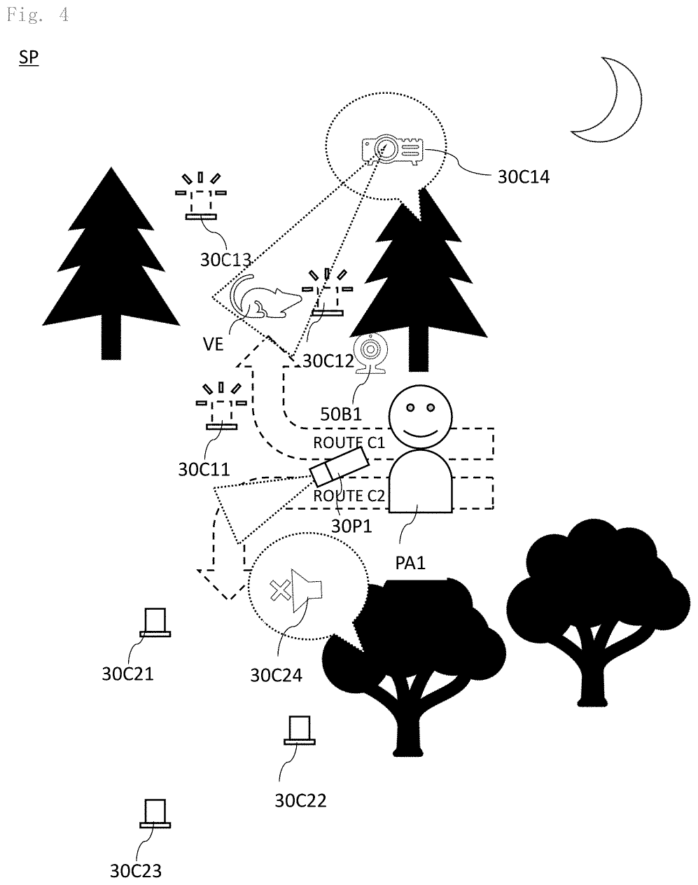

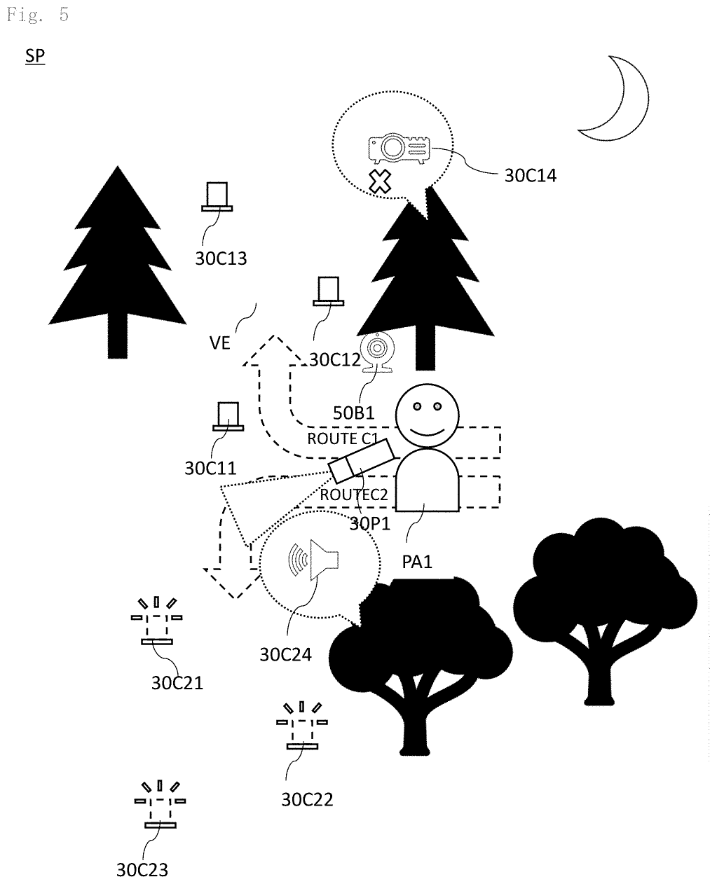

An outline of an exemplary embodiment will now be described. FIG. 3 is a diagram illustrating an outline of this embodiment. FIG. 4 is a diagram illustrating an outline of this embodiment. FIG. 5 is a diagram illustrating an outline of this embodiment.

As shown in FIG. 3, a plurality of routes are prepared in a space SP, and the participant PA1 can freely choose a route and walk along the chosen route. The routes may be either routes that can easily be recognized by the participant PA1 as geographical features indicating the direction of travel (for example, routes that can be visually recognized as naturally formed paths or paved paths) or routes on which the participant PA1 cannot easily recognize the direction of travel (for example, routes that are not clearly formed as paths or unpaved routes). The space SP may be indoors or outdoors, or may be divided into alternating indoor and outdoor sections. From the viewpoint of enhancing the effect of the visual effects (for example, video projection or light emission), the space SP is typically set in a dark environment (for example, a dark room or at night), but the space SP does not necessarily have to be set in a dark environment.

In the following description, it is assumed that the space SP is a forest at night. The participant PA1 carries the effect device 30P1 having the light-emitting means and advances by walking while illuminating the surroundings.

The effect device 30 and a state detection device 50B1 may be disposed in the space SP. In the example of FIG. 3, effect devices 30C11-30C14, effect devices 30C21-30C24, and the state detection device 50B1 are disposed in the space SP.

The effect control device 10 determines a route (referred to hereafter as a “recommended route”) to be recommended to the participant PA1 from two routes C1 and C2 having a branch area prepared within the space SP as a start point. The branch area is a location connected to a plurality of routes that the participant can enter. In each branch area, the participant chooses one of the plurality of routes branching from the branch area. The recommended route is, for example, an empty (in other words, uncrowded) route, a route predicted to meet the needs of the participant, a route on which the participant can enjoy effects the participant has not yet experienced, a route on which the participant can enjoy effects corresponding to a fee paid by the participant, and so on.

The effect control device 10 determines a recommended route individually for each guidance unit. The guidance unit is not limited to one participant and may be a plurality of participants (for example, friends, a family, a couple, or a plurality of participants who arrive at a branch area at the same timing).

For example, the effect control device 10 may determine a recommended route for the participant PA1 after detecting, via the state detection device 50B1, that the participant PA1 has reached the branch area.

The effect control device 10 guides the participant PA1 to the recommended route determined in relation to the participant PA1 by controlling the operations of the effect devices 30.

For example, the effect control device 10 may start to guide the participant PA1 after detecting, via the state detection device 50B1, that the participant PA1 has reached the branch area.

As shown in FIG. 4, the effect control device 10, having determined the route C1 as the recommended route, guides the participant PA1 to the route C1 by operating the effect devices 30C11-30C14 associated with the route C1.

For example, the effect control device 10 visually stimulates the participant PA1 to turn their attention to the route C1 by causing the effect devices 30C11-30C13 disposed near the entrance to the route C1 to emit light.

Further, the effect control device 10 visually stimulates the participant PA1 to turn their attention to the route C1 by projecting a predetermined video VE on the effect device 30C14 near the entrance to the route C1.

The predetermined video VE may be a video of a character having an animal motif, for example. The predetermined video VE may be a still image or a moving image. Furthermore, the effect control device 10 may further attract the attention of the participant PA1 by moving the position in which the video VE is projected along the route C1.

As shown in FIG. 5, the effect control device 10, having determined the route C2 as the recommended route, guides the participant PA1 to the route C2 by operating the effect devices 30C21-30C24 associated with the route C2.

For example, the effect control device 10 visually stimulates the participant PA1 to turn their attention to the route C2 by causing the effect devices 30C21-30C23 disposed near the entrance to the route C2 to emit light.

Further, the effect control device 10 aurally stimulates the participant PA1 to turn their attention to the route C2 by outputting a predetermined voice from the effect device 30C24 disposed near the entrance to the route C2. The predetermined voice may be a voice corresponding to the cry of a character having an animal motif, for example.

Thus, the walking support system 1 determines a recommended route for a participant in a space where the participant can freely choose a route and walk along the chosen route, and then guides the participant to the recommended route. As a result, with the walking support system 1, freedom for the participant to choose an action (for example, the freedom to choose the route C2 when the route C1 is determined as the recommended route or the freedom to choose the route C1 when the route C2 is determined as the recommended route) can be secured, and at the same time, the participant can be guided appropriately by being prompted to subconsciously turn their attention toward the recommended route.

As noted above, since the participant can walk through the space by freely choosing a route, the walking support system 1 does not restrict entry of the participant into a non-recommended route. In other words, the freedom of the participant to choose a route (referred to hereafter as a “non-recommended route”) other than the recommended route is guaranteed.

More specifically, the walking support system 1 does not perform at least one of the following operations.

Making it physically impossible to enter a non-recommended route.

Performing an effect that prevents the participant from finding non-recommended routes (for example, the effect control device 10 completely extinguishes the effect devices 30 near the entrances to non-recommended routes).

Performing an effect that creates the illusion of areas (referred to hereafter as “prohibited areas”) where the participant is prohibited from walking along non-recommended routes (for example, the effect control device 10 causes the effect device 30 to output a warning sound near the entrances to non-recommended routes).

Furthermore, whether or not the walking support system 1 has determined a given route as the recommended route does not affect the content of the experiences provided to the participant on that route. More specifically, of the effects relating to the route, effects not related to guidance toward the recommended route (for example, effects performed after route selection has been confirmed) may be set to be identical, regardless of the choice made by the participant. In other words, the effect control device 10 may cause the effect devices 30 associated with a given route to perform the same effects regardless of whether a participant for whom the given route has been determined as the recommended route or a participant for whom the given route has been determined as a non-recommended route traverses the route.

### (3) Databases

Databases of this embodiment will now be described. The following databases are stored in the storage device 11.

(3-1) Branch Area Database

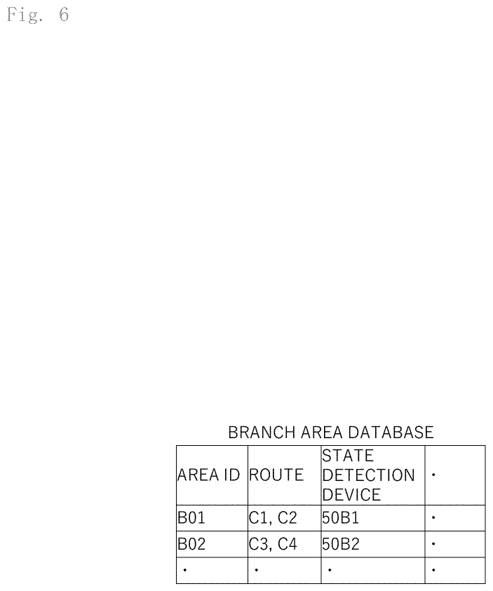

A branch area database according to this embodiment will now be described. FIG. 6 is a diagram showing a data structure of the branch area database according to this embodiment.

As shown in FIG. 6, the branch area database includes an “area ID” field, a “route” field, and a “state detection device” field. The respective fields are associated with each other.

The branch area database stores branch area information. The branch area information is information relating to the branch areas set in the space SP.

Area IDs are stored in the “area ID” field. The area ID is information for identifying a branch area.

Connected route information is stored in the “route” field. The connected route information is information relating to the routes that can branch from each branch area (in other words, routes having the branch area as a start point).

State detection device information is stored in the “state detection device” field. The state detection device information is information relating to the state detection device 50 that is associated with the branch area (in other words, the state detection device 50 that is disposed in the branch area).

(3-2) Route Database

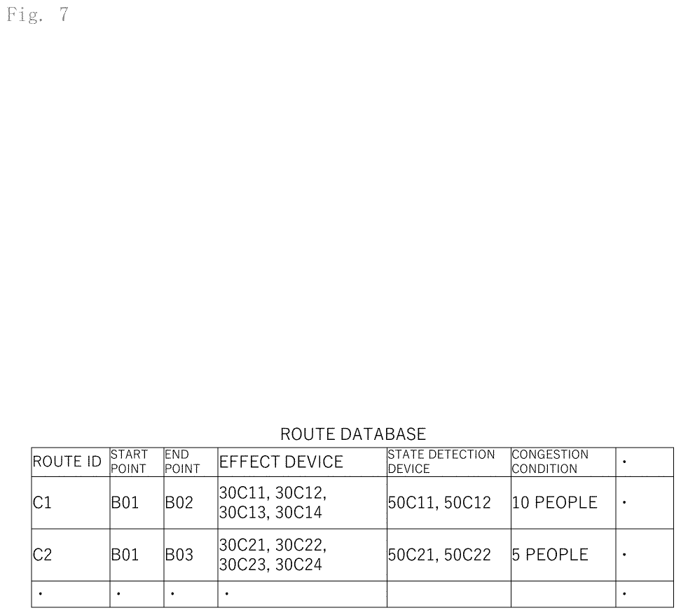

A route database according to this embodiment will now be described. FIG. 7 is a diagram showing a data structure of the route database according to this embodiment.

As shown in FIG. 7, the route database includes a “route ID” field, a “start point” field, an “end point” field, an “effect device” field, a “state detection device” field, and a “congestion condition” field. The respective fields are associated with each other.

The route database stores route information. The route information is information relating to the routes set in the space SP.

Route IDs are stored in the “route ID” field. The route ID is information for identifying a route.

Start point information is stored in the “start point” field. The start point information is information relating to the start point of the route. The start point of the route can be set in the branch area or at the entrance to the space SP. Note that the entrance to the space SP may be one of the branch areas.

End point information is stored in the “end point” field. The end point information is information relating to the end point of the route. The end point of the route can be set in the branch area or at the exit from the space SP.

Effect device information is stored in the “effect device” field. The effect device information is information relating to the effect devices 30 associated with the route (for example, the effect devices 30 disposed on the route or the effect device 30 disposed at the start point or the end point of the route).

State detection device information is stored in the “state detection device” field. The state detection device information is information relating to the state detection device 50 that is associated with the route (for example, the state detection device 50 disposed on the route or the state detection device 50 disposed at the start point or the end point of the route).

Congestion condition information is stored in the “congestion condition” field. The congestion condition information is information relating to the congestion condition of the route.

The congestion condition information can be updated dynamically by referring to the detection result obtained by the state detection device 50 associated with the route, for example.

(3-3) Participant Database

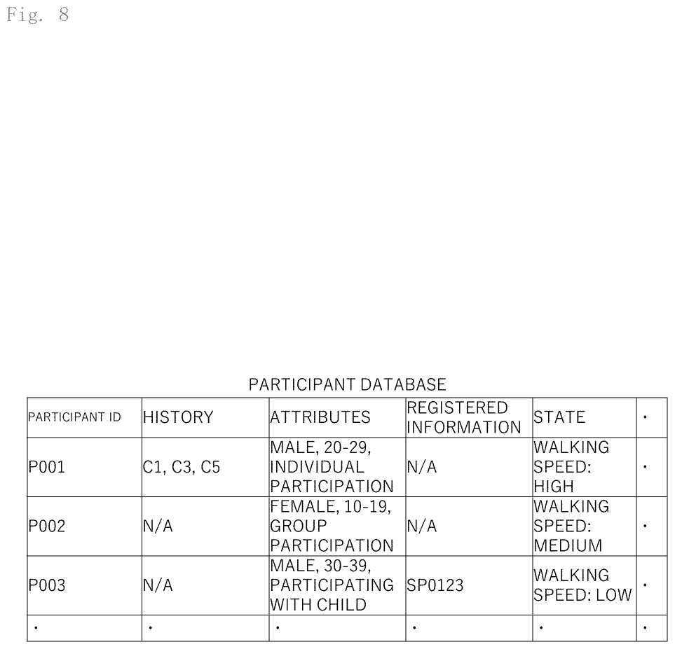

A participant database according to this embodiment will now be described. FIG. 8 is a diagram showing a data structure of the participant database according to this embodiment.

As shown in FIG. 8, the participant database includes a “participant ID” field, a “walking history” field, an “attribute” field, a “registered information” field, and a “state” field. The respective fields are associated with each other.

The participant database stores participant information. The participant information is information relating to the participants.

Participant IDs are stored in the “participant ID” field. The participant ID is information for identifying a participant.

The participant ID may be included in data transmitted from the effect device 30 carried by the participant or another device, for example.

History information is stored in the “history” field. The history information is information relating to a history of past experiences of the participant.

For example, the history information includes information relating to routes selected in the past by the participant, information relating to effects experienced in the past by the participant, or a combination thereof.

The history information can be acquired by means of self-reporting by the participant, for example. For example, each time the participant finishes walking through the space SP, a code (for example, a QR code (Registered Trademark) or another two-dimensional barcode) indicating the routes selected by the participant or the effects experienced by the participant is issued. The participant can easily report their own history information by presenting the issued code to a code reader when walking through the space SP again. The code reader is disposed at the entrance to the space SP, in the branch area, or midway along a route, for example.

Attribute information is stored in the “attribute” field. The attribute information is information relating to attributes of the participant.

For example, the attribute information includes the age group, sex, or manner of participation (for example, individual participation, group participation, or participation with children) of the participant, or a combination thereof.

The attribute information may be acquired by means of self-reporting by the participant or estimated by referring to the detection result acquired by the state detection device 50.

Registered information is stored in the “registered information” field. The registered information is information relating to content registered by the participant.

For example, the registered information is a code registered by the participant and assigned to a specific route.

For example, the code assigned to the specific route may be attached to a product related to an event set in the space SP, or the code itself may be sold as a product. To prevent unauthorized use, the code may be set so as to be valid for one use only.

For example, the participant can easily register the code assigned to a specific route by presenting a code attached to a product (an event pamphlet, for example) acquired by the participant to a code reader. The code reader is disposed at the entrance to the space SP, in the branch area, or midway along a route, for example.

State information is stored in the “state” field. The state information is information relating to the state of the participant.

As noted above, the state of the participant is, for example, the location of the participant, the attitude of the participant, the total walking distance of the participant, the total walking time of the participant, the walking speed of the participant, the vitals of the participant, or a combination thereof.

The state information can be updated dynamically by referring to the detection result acquired by the state detection device 50.

### (4) Walking Support Processing

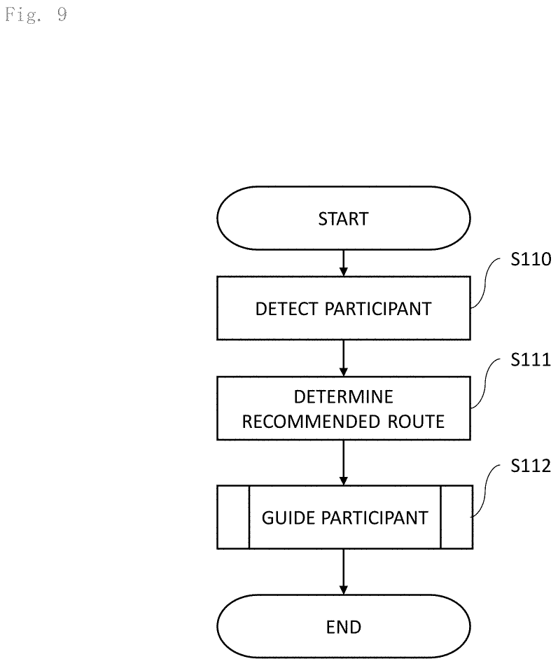

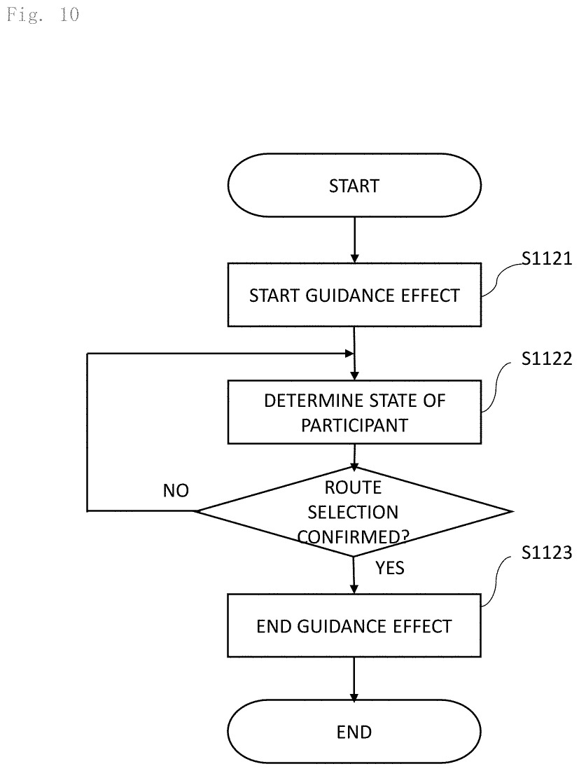

Walking support processing according to this embodiment will now be described. FIG. 9 is a flowchart showing walking support processing according to this embodiment. FIG. 10 is a flowchart showing an example of participant guidance processing shown in FIG. 9.

As shown in FIG. 9, the effect control device 10 executes detection of the participant (S110).

More specifically, the processor 12 detects that the participant has reached the branch area by referring to the detection result acquired by the state detection device 50.

Individual identification of a participant who has reached the branch area may also be performed. For example, individual identification of a participant may be performed by transmitting data including the participant ID from the effect device 30 carried by the participant or another device. Alternatively, by registering the face of the participant or another feature in advance, individual identification of a participant may be performed by means of image recognition, for example.

Following step S110, the effect control device 10 executes recommended route determination (S111).

More specifically, the processor 12 determines a recommended route for the participant (referred to hereafter as the “subject participant”) detected in step S110.

In a first example of step S111, the processor 12 determines a recommended route for the subject participant on the basis of the distribution of people in the space SP.

For example, the processor 12 specifies the routes associated with the branch area (referred to hereafter as the “subject branch area”) detected in step S110 by referring to the branch area database (FIG. 6). The processor 12 then acquires the congestion condition information of the specified routes by referring to the route database (FIG. 7).

By referring to the acquired congestion condition information, the processor 12 determines a recommended route for the subject participant such that the participants are dispersed over the plurality of specified routes. More specifically, any one of the following routes may be determined as the recommended route.

The least crowded route (for example, the route on which the number of walking participants is smallest or the route on which the population density (the number of participants per surface area) of walking participants is smallest)

The route that was last determined as the recommended route the longest time ago

The route on which the distance to another participant who is the closest participant to the subject branch area is greatest (in other words, the route on which the interval between the subject participant and another participant ahead of the subject participant is greatest)

According to the first example of step S111, a route with little congestion, on which it is possible to enjoy events safely and comfortably, is determined as the recommended route.

In a second example of step S111, the processor 12 determines a recommended route for the subject participant on the basis of information relating to the subject participant. For example, the processor 12 specifies the routes associated with the subject branch area by referring to the branch area database (FIG. 6).

The processor 12 then acquires information relating to the subject participant by referring to the participant database (FIG. 8). By referring to the acquired information relating to the subject participant, the processor 12 determines one of the plurality of specified routes as the recommended route for the subject participant. More specifically, any one of the following routes may be determined as the recommended route.

A different route to the routes selected by the subject participant in the past (see the history information)

A route related to the routes selected by the subject participant in the past (for example, a route on which it is possible to have experiences relating to the routes selected in the past)

A specific route to which the code registered by the subject participant is assigned (see the registered information)

A route corresponding to the walking speed of the subject participant (for example, when the walking speed of the subject participant is high, a route with a long total distance, and when the walking speed of the subject participant is low, a route with a short total distance)

A route corresponding to the manner of participation of the subject participant (for example, when the subject participant is participating with children, a route that is suitable for children)

In a third example of step S111, the processor 12 determines a recommended route for the subject participant in accordance with a predetermined pattern.

The processor 12 specifies the routes associated with the subject branch area by referring to the branch area database (FIG. 6). The processor 12 then determines one of the plurality of specified routes as the recommended route of the subject participant in accordance with a predetermined pattern. For example, the processor 12 determines the recommended route such that the route ID changes in descending order or ascending order in guidance units.

A fourth example of step S111 is a combination of at least two of the first to third examples described above.

For example, the processor 12 determines the recommended route in accordance with the second example when history information or registered information exists in relation to the subject participant, and determines the recommended route in accordance with the first example or the third example when history information or registered information does not exist in relation to the subject participant.

Following step S111, the effect control device 10 executes participant guidance (S112).

More specifically, the processor 12 guides the participant to the recommended route in accordance with the recommended route determined in step S111.

At the start of step S112, as shown in FIG. 10, the effect control device 10 executes the start of a guidance effect (S1121).

More specifically, the processor 12 specifies the effect devices 30 associated with the recommended route by referring to the route database (FIG. 7). The processor 12 then applies sensory stimulation to the participant by controlling the operations of the specified effect devices 30.

Following step S1121, the effect control device 10 executes determination of the state of the participant (S1122).

More specifically, the processor 12 determines whether or not route selection by the subject participant has been confirmed by referring to the detection result (the location of the subject participant, for example) of the state detection device 50 (for example, the state detection device 50 associated with the subject branch area).

For example, the processor 12 determines that route selection by the subject participant has not been confirmed when the subject participant is within the branch area, and determines that route selection by the subject participant has been confirmed when the subject participant has entered one of the routes associated with the branch area.

When it is determined in step S1122 that route selection by the subject participant has been confirmed, the effect control device 10 executes termination of the guidance effect (S1123).

More specifically, the processor 12 stops the operations of the effect devices 30 controlled in step S1121 or returns the effect devices 30 to the operation states thereof prior to the start of step S1121.

As noted above, of the effects relating to the route, effects not related to guidance toward the recommended route (for example, effects performed after route selection has been confirmed) may be set to be identical, regardless of the choice made by the participant. In other words, the effect control device 10 may cause the effect devices 30 associated with a given route to perform the same effects regardless of whether a participant for whom the given route has been determined as the recommended route or a participant for whom the given route has been determined as a non-recommended route traverses the route. For example, the processor 12 may return the emission strength or emission colors of the effect devices 30 to the states thereof prior to the start of step S1121.

When it is determined in step S1122 that route selection by the subject participant has not been confirmed, the effect control device 10 re-executes determination of the state of the participant (S1122).

### (5) SUMMARY

As described above, the walking support system according to this embodiment determines a recommended route for a participant in a space where the participant can freely choose and walk along a route, and guides the participant to the recommended route. According to this walking support system, therefore, freedom for the participant to choose an action can be secured, and at the same time, the participant can be guided appropriately by being prompted to subconsciously turn their attention toward the recommended route.

### (6) Modification Examples

Modification examples of this embodiment will now be described.

### (6-1) Modification Example 1

Modification example 1 will now be described.

Modification example 1 is an example in which the effect content implemented for the purpose of guidance is controlled dynamically in accordance with the state of the subject participant.

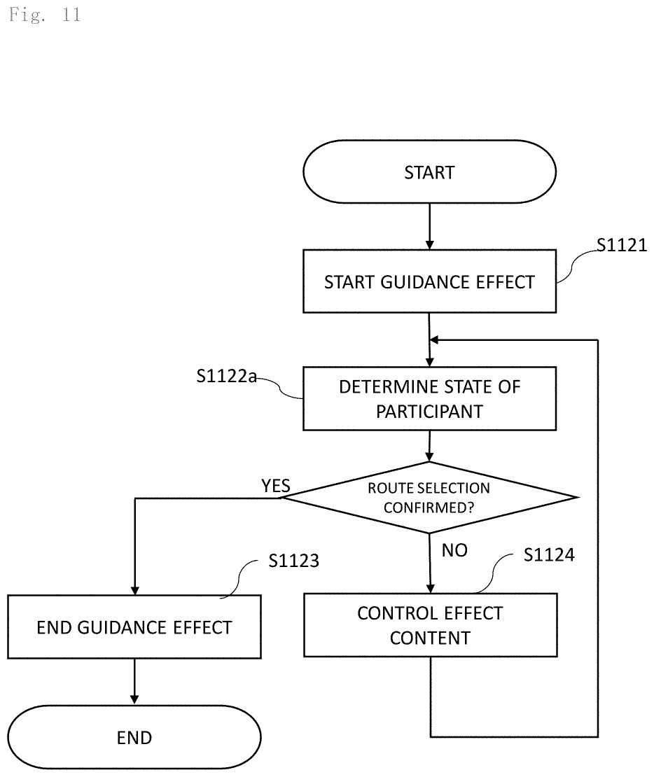

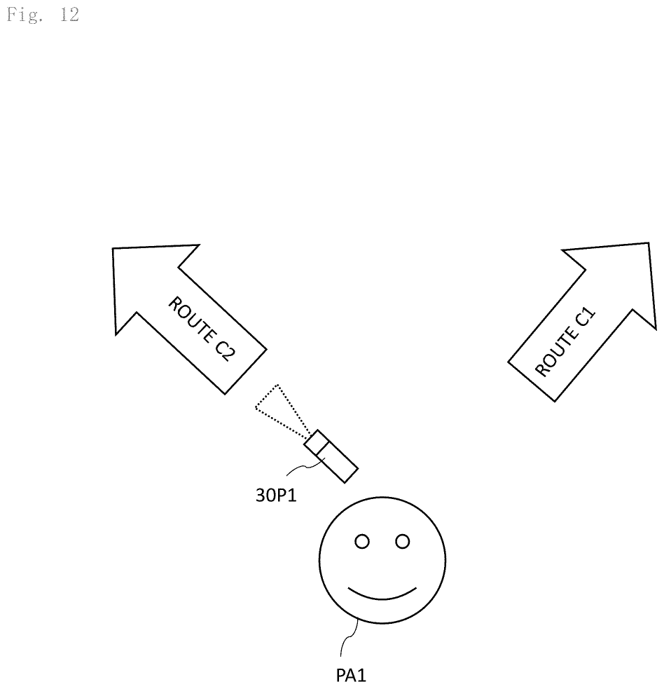

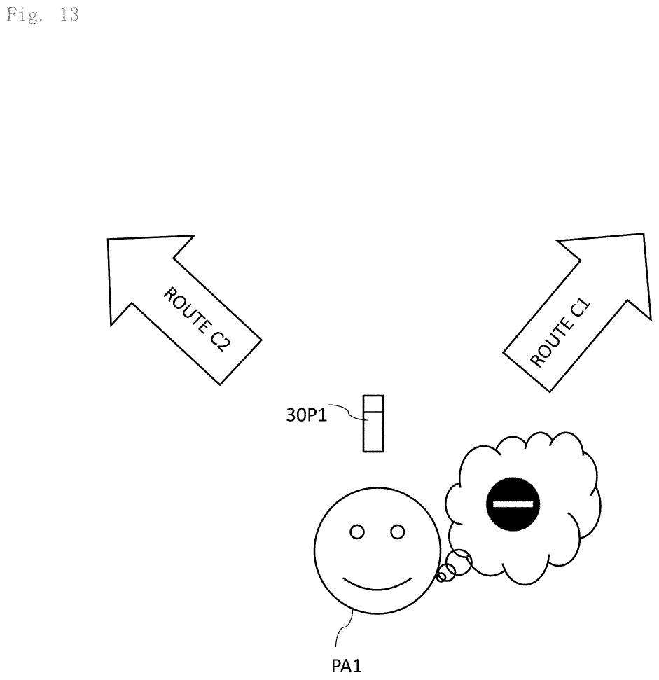

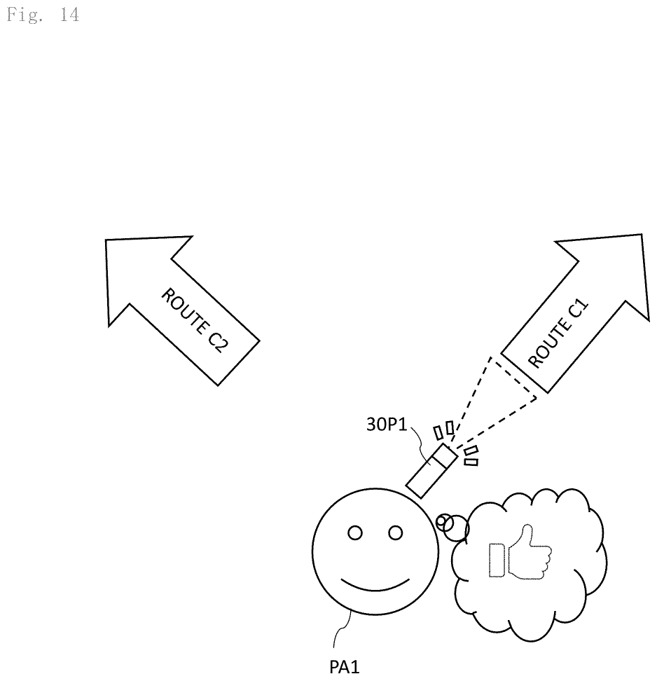

Walking support processing according to modification example 1 will now be described. FIG. 11 is a flowchart showing an example of participant guidance processing according to modification example 1. FIG. 12 is a diagram showing an example of effect content implemented for the purpose of guidance. FIG. 13 is a diagram showing an example of effect content implemented for the purpose of guidance. FIG. 14 is a diagram showing an example of effect content implemented for the purpose of guidance.

The effect control device 10 executes participant detection (S110) and recommended route determination (S111) in a similar manner to FIG. 9.

Following step S111, the effect control device 10 executes participant guidance (S112).

At the start of step S112, as shown in FIG. 11, the effect control device 10 executes the start of the guidance effect (S1121) (similar to FIG. 10).

Following step S1121, the effect control device 10 executes determination of the state of the participant (S1122a).

More specifically, the processor 12 determines whether or not route selection by the subject participant has been confirmed by referring to the detection result (the location of the subject participant, for example) of the state detection device 50 (for example, the state detection device 50 associated with the subject branch area). Further, when route selection by the subject participant has not been confirmed, the processor 12 determines which of first to third states, described below, the subject participant is in.

The first state is a state in which the subject participant is oriented toward the recommended route. For example, the processor 12 can determine that the subject participant is in the first state when the body or the gaze of the subject participant is oriented toward the recommended route, when the effect device 30 carried by the subject participant or another device is oriented toward the recommended route, or when the subject participant is moving in a direction approaching the recommended route.

The second state is a state in which the subject participant is oriented toward a non-recommended route other than the recommended route, among the routes associated with the subject branch area. For example, the processor 12 can determine that the subject participant is in the second state when the body or the gaze of the subject participant is oriented toward a non-recommended route, when the effect device 30 carried by the subject participant or another device is oriented toward a non-recommended route, or when the subject participant is moving in a direction approaching a non-recommended route.

The third state is a state in which the subject participant is oriented in a different direction to any of the routes. For example, the processor 12 can determine that the subject participant is in the third state when the body or the gaze of the subject participant is oriented in a different direction to any of the routes, when the effect device 30 carried by the subject participant or another device is oriented in a different direction to any of the routes, or when the subject participant is moving in a different direction to any of the routes.

When it is determined in step S1122a that route selection by the subject participant has been confirmed, the effect control device 10 executes termination of the guidance effect (S1123), similarly to FIG. 10.

When it is determined in step S1122a that route selection by the subject participant has not been confirmed, the effect control device 10 executes control of the effect content (S1124).

More specifically, the processor 12 controls the operations of the effect devices 30 in accordance with the determination result acquired in step S1122a.

For example, when the subject participant is in the first state, the processor 12 controls the effect devices 30 so as to apply first sensory stimulation to the subject participant. Further, when the subject participant is in the second state, the processor 12 may control the effect devices 30 so as to apply second sensory stimulation, which is weaker than the first sensory stimulation, to the subject participant. Furthermore, when the subject participant is in the third state, the processor 12 may control the effect devices 30 so as to apply different sensory stimulation to either the first sensory stimulation or the second sensory stimulation to the subject participant, or so as to stop the operations.

When the recommended route is the route C1, the processor 12 can dynamically control the effect content of the effect device 30P1 carried by the subject participant PA1 as shown in FIGS. 12 to 14.

As shown in FIG. 12, when the subject participant PA1 is oriented toward the route C2 (i.e., in the second state), the processor 12 causes the effect device 30P1 to emit light at a second emission strength, which is weaker than a first emission strength. As a result, the subject participant PA1 is made aware of the existence of the route C2.

As shown in FIG. 13, when the subject participant PA1 is not oriented toward either the route C1 or the route C2 (i.e., in the third state), the processor 12 extinguishes the effect device 30P1. As a result, the subject participant PA1 can be made to recognize that it impossible to proceed.

As shown in FIG. 14, when the subject participant PA1 is oriented toward the route C1 (i.e., in the first state), the processor 12 causes the effect device 30P1 to emit light at the first emission strength. As a result, the subject participant PA1 is made more strongly aware of the existence of the route C1 than the route C2.

The strength of the sensory stimulation can be adjusted by various methods, as described below.

The sensory stimulation can be strengthened by increasing the emission strength.

The sensory stimulation can be strengthened by setting an emission color (a warning color, for example) that is more likely to draw the attention of a person.

When light is emitted intermittently, the sensory stimulation can be weakened by lengthening the period during which emission is halted.

The sensory stimulation can be strengthened by increasing the brightness of the image or video.

The sensory stimulation can be strengthened by increasing the sound pressure.

The sensory stimulation can be strengthened by increasing the vibration amplitude.

The sensory stimulation can be strengthened by combining more types of sensory stimulation (for example, by combining light emission, voice, and vibration).

As described above, the walking support system according to modification example 1 dynamically controls the effect content implemented for the purpose of guidance in accordance with the state of the subject participant. Hence, according to this walking support system, in addition to the effects of the embodiment, it is possible to increase the interest of the participant in observing the surroundings and finding a route in the branch area.

### (7) Other Modification Examples

The storage device 11 may be connected to the storage device 11 by the network NW.

Some or all of the functions of the effect control device 10 may be incorporated into a device (for example, the effect device 30, the state detection device 50, or a combination thereof) carried by the participant.

In the embodiment, an example in which guidance is realized by controlling the operations of the effect devices 30 associated with the recommended route was described. However, the effect control device 10 may also control the operations of the effect devices 30 associated with the non-recommended route.

More specifically, the effect control device 10 may control the effect devices 30 associated with the recommended route so as to apply a certain type of sensory stimulation to the participant and control the effect devices 30 associated with the non-recommended route so as to apply weaker sensory stimulation to the participant.

For example, the effect control device 10 may cause the effect devices 30 associated with the recommended route to emit light at a certain emission strength and cause the effect devices 30 associated with the non-recommended route to emit light at a weaker emission strength. Thus, the participant can also be made aware of the existence of the non-recommended route while drawing the attention of the participant toward the recommended route. In other words, the participant can be given the sense of being able to actively select the route.

In this modification example, from the viewpoint of safety, when it is confirmed that the participant has chosen the non-recommended route, the effect control device 10 may control the effect devices 30 associated with the non-recommended route chosen by the participant so as to apply stronger sensory stimulation to the participant than before route selection was confirmed. For example, the effect control device 10 may increase the emission strength of the effect devices 30 associated with the non-recommended route chosen by the participant. As a result, the road surface and the surrounding conditions can be ascertained easily, enabling the participant to continue to walk safely and comfortably.

An example in which a recommended route for the participant is determined in response to detection of the arrival of the participant at the branch area was described. However, a recommended route may be determined for the participant in response to another trigger.

For example, recommended routes may be determined for the participant all at once at the start of the walk.

Alternatively, the recommended route of the participant may be determined when a route having the subject branch area as the end point is selected, or determined in response to detection of a predetermined state in the participant or the space.

In this modification example, the guidance effect can be started in response to detection of the arrival of the participant in the branch area.

An example in which the operation of the effect device 30 carried by the participant is controlled in accordance with the state of the participant was described. Instead, however, the operations of the effect devices 30 carried by participants having a specific attribute may be set to be identical, regardless of the states of the participants.

For example, participants may be guided to the recommended route by maintaining the emission strength of the effect devices 30 carried by children, elderly people, or disabled people at a high level regardless of the states of these people and controlling the operations of the effect devices 30 disposed in the space SP (for example, controlling the emission strength). Thus, guidance can be realized in consideration of the safety of the participants.

An example in which the operation of the effect device 30 carried by the participant is controlled in accordance with the state of the participant was described. However, in a case where a plurality of participants walk together in a group, this control may be performed only on the effect devices 30 carried by some of the plurality of participants, while the operations of the effect devices 30 carried by the remaining participants are set to be identical regardless of the states of the participants.

For example, when adults and children walk together in a group, the emission strength of the effect devices 30 carried by the adults may be increased or reduced in accordance with the states of these people, while the emission strength of the effect devices 30 carried by the children are maintained at a high level regardless of the states of these people. Thus, guidance can be realized in consideration of the safety of the participants.

When a plurality of participants walk together in a group, the participants may be prevented from straying from the group by performing effects in accordance with the distances between the effect devices 30 carried by the participants.

For example, when an adult and a child walk together in a group and the effect device 30 carried by the child strays from the effect device 30 carried by the adult by a distance exceeding a threshold, the effect devices 30 carried by one or both thereof may output a warning sound or light up in a different color to normal. Thus, the participants can be alerted and prompted to voluntarily regroup.

In the space, areas (referred to hereafter as “allowed areas”; for example, the entrance, the exit, the routes, and the branch areas) in which the participants are allowed to walk may be separated physically or virtually from the prohibited areas.

As examples of separating the allowed areas from the prohibited areas physically, a boundary can be set between the two areas by disposing a man-made object such as a fence or a wall, the location of a natural object such as a tree or a river may be set as the boundary between the two areas, or a combination thereof may be employed.

As examples of separating the allowed areas from the prohibited areas virtually, the effect device 30 carried by the participant may be caused to perform different operations when the participant is in an allowed area and when the participant is in a prohibited area. For example, when the participant is in a prohibited area, the effect device 30 carried by the participant may output a warning sound or light up in a different color to normal. Thus, the participant can be alerted and prompted to return to an allowed area. Moreover, when the participant is in a prohibited area, the event organizer may be notified thereof. Thus, the event organizer can hurry to the site and return the participant to an allowed area.

Virtually separating the allowed areas from the prohibited areas has advantages in that the load involved in installing man-made objects and the adverse effects thereof on the atmosphere created by the space (for example, a reduction in the sense of openness) can be avoided, the allowed areas and prohibited areas can be designed without being affected by the arrangement of natural objects, and so on.

The traversable directions of the routes may be set, but do not have to be set.

For example, a route may be set so as to be traversable only in a direction (a forward direction) extending from the entrance to the exit of the space.

As another example, the route may be set so as to be traversable both in a forward direction and an opposite direction thereto. In this example, the participant can, either unconditionally or conditionally, travel back along a selected route so as to return to the immediately preceding branch area.

It was stated in the embodiment that the recommended route is determined, but the non-recommended routes may be determined first. Likewise according to this example, the route, among the plurality of routes, that is not determined as a non-recommended route is in practical terms determined as the recommended route.

The effect control device 10 can determine a recommended route for the participant in relation to the branch area at which the participant has arrived. Here, information indicating whether the route (referred to hereafter as the “first route”) that was used by the participant (in other words, traversed by the participant) in order to reach a given branch area (referred to hereafter as the “second branch area”) was the recommended route or a non-recommended route in relation to the branch area (referred to hereafter as the “first branch area”) immediately preceding the second branch area may affect, but does not have to affect, determination of a recommended route for the participant in relation to the second branch area. As an example of the latter, when the participant arrives at the second branch area by traversing the first route from the first branch area, the effect control device 10 may determine a recommended route for the participant in relation to the second branch area without referring to the information indicating whether the first route was the recommended route or a non-recommended route for the participant in relation to the first branch area.

An exemplary embodiment of the present disclosure was described in detail above, but the scope of the present disclosure is not limited to the above embodiment. Moreover, various amendments and modifications may be applied to the above embodiment within a scope that does not depart from the spirit of the present disclosure. Furthermore, the embodiment and the modification examples described above may be combined.

### (8) Supplements

The matters described in the embodiment are supplemented as follows.

(Supplement 1)

A walking support system (1) including: means (S111) for determining a recommended route for a participant in a space where the participant can choose and walk along a route; and means (S112) for guiding the participant to the recommended route without restricting entry of the participant into a non-recommended route, which is a different route to the recommended route.

(Supplement 2)

The walking support system described in supplement 1, wherein the means for determining a recommended route determines a recommended route for the participant on the basis of a distribution of participants in the space.

(Supplement 3)

The walking support system described in supplement 1 or supplement 2, wherein the means for determining a recommended route determines a recommended route for the participant such that the participants are dispersed over a plurality of routes set in the space.

(Supplement 4)

The walking support system described in any of supplements 1 to 3, wherein the means for determining a recommended route determines a recommended route for the participant on the basis of information relating to the participant.

(Supplement 5)

The walking support system described in supplement 4, wherein the information relating to the participant includes at least one of history information relating to the participant, registered information registered by the participant, attribute information relating to the participant, and state information relating to the participant.

(Supplement 6)

The walking support system described in supplement 5, wherein the means for determining a recommended route determines, as the recommended route, a different route to routes that are indicated in the history information of the participant as having been selected by the participant in the past.

(Supplement 7)

The walking support system described in supplement 5, wherein the means for determining a recommended route determines, as the recommended route, a specific route to which a code indicated in the registered information of the participant is assigned.

(Supplement 8)

The walking support system described in any of supplements 1 to 7, wherein the space includes a plurality of branch areas including a first branch area and a second branch area,

the walking support system includes means (S1122) for determining the state of the participant, the means for determining a recommended route determines a recommended route for the participant in relation to the branch area at which the participant has arrived, and

when the participant arrives at the second branch area by traversing a first route from the first branch area, the means for determining a recommended route determines a recommended route for the participant in relation to the second branch area without referring to information indicating whether the first route was the recommended route or a non-recommended route for the participant in relation to the first branch area.

(Supplement 9)

The walking support system described in any of supplements 1 to 8, wherein the means for guiding the participant guides the participant by controlling, in accordance with the recommended route, an operation of an effect device (30) that is capable of applying sensory stimulation to the participant.

(Supplement 10)

The walking support system described in supplement 9, wherein the effect device includes at least one of an effect device carried by the participant and an effect device disposed in the space.

(Supplement 11)

The walking support system described in supplement 9 or supplement 10, wherein the effect device comprises a light-emitting means, and

the means for guiding the participant guides the participant by causing the effect device to emit light.

(Supplement 12)

The walking support system described in any of supplements 9 to 11, wherein the effect device comprises means for outputting a voice, and

the means for guiding the participant guides the participant by causing the effect device to output a predetermined voice.

(Supplement 13)

The walking support system described in any of supplements 9 to 12, wherein the effect device comprises means for projecting a video into the space, and

the means for guiding the participant guides the participant by causing the effect device to project a predetermined video.

(Supplement 14)

The walking support system described in any of supplements 9 to 13, further including means (S1122a) for determining the state of the participant,

wherein the means for guiding the participant controls the effect device so that when the participant is in a first state, first sensory stimulation is applied to the participant.

(Supplement 15)

The walking support system described in supplement 14, wherein the first state is a state in which the participant is oriented toward the recommended route.

(Supplement 16)

The walking support system described in supplement 14 or supplement 15, wherein the means for guiding the participant guides the participant by controlling the effect device so that when the participant is in a second state, second sensory stimulation, which is weaker than the first sensory stimulation, is applied to the participant.

(Supplement 17)

A walking support method including having a computer: determine a recommended route for a participant in a space where the participant can choose and walk along a route (S11); and

guide the participant to the recommended route without restricting entry of the participant into a non-recommended route, which is a different route to the recommended route (S112).

(Supplement 18)

A walking support program for causing a computer to function as:

means (S111) for determining a recommended route for a participant in a space where the participant can choose and walk along a route; and

means (S112) for guiding the participant to the recommended route without restricting entry of the participant into a non-recommended route, which is a different route to the recommended route.

1. A walking support system, comprising:
processing circuitry configured to
determine a recommended route for a participant in a space where the participant can choose and walk along a route; and
guide the participant to the recommended route without restricting entry of the participant into a non-recommended route, which is a different route to the recommended route.

2. The walking support system according to claim 1, wherein the processing circuitry for determining a recommended route is further configured to
determine a recommended route for the participant based on a distribution of participants in the space.

3. The walking support system according to claim 1, wherein the processing circuitry for determining a recommended route is further configured to
determine a recommended route for the participant such that the participants are dispersed over a plurality of specified routes set in the space.

4. The walking support system according to claim 1, wherein the processing circuitry for determining a recommended route is further configured to
determine a recommended route for the participant based on information relating to the participant.

5. The walking support system according to claim 4, wherein the information relating to the participant includes at least one of history information relating to the participant, registered information registered by the participant, attribute information relating to the participant, and state information relating to the participant.

6. The walking support system according to claim 5, wherein the processing circuitry for determining a recommended route is further configured to
determine, as the recommended route, a different route to routes that are indicated in the history information of the participant as having been selected by the participant in the past.

7. The walking support system according to claim 5, wherein the processing circuitry for determining a recommended route is further configured to
determine, as the recommended route, a specific route to which a code indicated in the registered information of the participant is assigned.

8. The walking support system according to claim 1, wherein the space includes a plurality of branch areas including a first branch area and a second branch area,
wherein the processing circuitry is further configured to determine the state of the participant,
wherein the processing circuitry for determining a recommended route is further configured to
determine a recommended route for the participant in relation to the branch area at which the participant has arrived, and
in response to the participant arriving at the second branch area by traversing a first route from the first branch area, determine a recommended route for the participant in relation to the second branch area without referring to information indicating whether the first route was the recommended route or a non-recommended route for the participant in relation to the first branch area.

9. The walking support system according to claim 8, wherein the processing circuitry for guiding the participant is further configured to
guide the participant by controlling, in accordance with the recommended route, an operation of an effect device that applies sensory stimulation to the participant.

10. The walking support system according to claim 9, wherein the effect device includes at least one of an effect device carried by the participant and an effect device disposed in the space.

11. The walking support system according to claim 9, wherein the effect device comprises a light source, and
the processing circuitry for guiding the participant is further configured to guide the participant by causing the effect device to emit light.

12. The walking support system according to claim 9, wherein the effect device comprises a speaker, and
the processing circuitry for guiding the participant is further configured to guide the participant by causing the effect device to output a predetermined voice.

13. The walking support system according to claim 9, wherein the effect device comprises means for projecting a video into the space, and
the processing circuitry for guiding the participant is further configured to guide the participant by causing the effect device to project a predetermined video.

14. The walking support system according to claim 9, wherein the processing circuitry is further configured to determine the state of the participant, and
wherein the processing circuitry for guiding the participant is further configured to control the effect device so that when the participant is in a first state, first sensory stimulation is applied to the participant.

15. The walking support system according to claim 14, wherein the first state is a state in which the participant is oriented toward the recommended route.

16. The walking support system according to claim 14, wherein the processing circuitry for guiding the participant is further configured to guide the participant by controlling the effect device so that when the participant is in a second state, second sensory stimulation, which is weaker than the first sensory stimulation, is applied to the participant.

17. A walking support method, comprising:
determining a recommended route for a participant in a space where the participant can choose and walk along a route; and
guiding the participant to the recommended route without restricting entry of the participant into a non-recommended route, which is a different route to the recommended route.

18. A non-transitory computer-readable walking support program storing computer-readable instructions thereon which, when executed by a computer cause the computer to perform a method, the method comprising:
determining a recommended route for a participant in a space where the participant can choose and walk along a route; and
guiding the participant to the recommended route without restricting entry of the participant into a non-recommended route, which is a different route to the recommended route.
